(19) United States
(12) Patent Application Publication
(10) Pub. No.: US 2022/0120711 A1
(43) Pub. Date: Apr. 21, 2022

(54) METHOD AND APPARATUS FOR MONITORING THE INTEGRITY OF A WIRE ROPE ASSEMBLY

(71) Applicants: Jo Wickert, Meersburg (DE); Pierre Verreet, Zug (CH)

(72) Inventor: Jo Wickert, Meersburg (DE)

(21) Appl. No.: 17/499,247

(22) Filed: Oct. 12, 2021

(30) Foreign Application Priority Data
Oct. 15, 2020 (DE) 102020127250.2

(51) Int. Cl. G01N 27/82; E01D 19/16

(52) U.S. Cl. CPC G01N 27/82; E01D 11/02; E01D 19/16

(57) ABSTRACT

A method and an apparatus monitor the integrity of a wire rope in a wire rope assembly, as well as a wire rope assembly containing such an apparatus. In this case, the wire rope is moved past a sensor device, and a sensor signal is generated with the aid of the sensor device. The sensor signal characterizes a magnetic interaction between the sensor device and the wire rope moving past the sensor device. A measure for the integrity of the wire rope is determined on the basis of the generated sensor signal. Accordingly, the movement of the wire rope is generated here in a normal operation of the wire rope assembly.

The present invention relates to a method and an apparatus for monitoring the integrity of a wire rope in a wire rope assembly, and to a wire rope assembly comprising such an apparatus.

Wire ropes are often used to carry or lash large loads and consist of multiple wires that are usually twisted into braids or strands. These, in turn, are usually wrapped around an insert called a core. In some cases, however, such as when used in suspension bridges, the wires can also be arranged parallel to each other without being twisted. In this case, the wires are usually pressed together with rope clips.

Over time, stress can compromise the integrity of a wire rope. For example, individual wires may break or at least tear. This occurs, for example, when the wire rope is frequently bent, such as at sheaves or pulleys used to deflect the wire rope. Corrosion or another chemical process may possible also contribute to the failure of individual wires. The problem here is that wire portions running inside the wire rope cannot be visually inspected for integrity. Therefore, non-invasive methods based on magnetic interactions have been developed and can be used to perform maintenance operations on wire ropes at regular intervals.

It is an object of the present invention to further improve the checking of wire ropes for their integrity, in particular to increase the operational reliability of wire rope assemblies comprising a wire rope and/or to minimize downtimes.

This object is achieved by a method and an apparatus for monitoring the integrity of a wire rope in a wire rope assembly as well as by a wire rope assembly comprising such an apparatus according to the independent claims.

In a method for monitoring the integrity of a wire rope in a wire rope assembly according to a first aspect of the invention, (i) the wire rope is moved past a sensor device, (ii) a sensor signal is generated with the aid of the sensor device, which sensor signal characterizes a magnetic interaction between the sensor device and the wire rope moved past the sensor device, and (iii) a measure for the integrity of the wire rope, hereinafter occasionally also referred to as integrity measure for short, is determined on the basis of the generated sensor signal. According to the invention, the movement of the wire rope is generated here in a normal operation of the wire rope assembly.

One aspect of the invention is based on the approach of using a magnet-based detection method to generate or provide information about the condition of a wire rope of a wire rope assembly, more specifically preferably during normal or controlled operation of the wire rope assembly. In other words, the wire rope assembly, for example a cable car installation or a hoisting installation such as a crane, can (still) be operated unimpaired, in particular without interruption, during a measurement of at least one variable on the basis of which the integrity of the wire rope can be assessed. For this purpose, the wire rope is preferably moved past a, preferably stationary, sensor device, for example is guided in portions through or along the sensor device, in such a way that the sensor device generates a sensor signal. Thus, the wire rope can be monitored substantially continuously. In particular, this enables a high level of operational reliability. In addition, the wire rope assembly can also be operated particularly economically, since no downtimes for maintenance purposes are necessary.

To enable detection during normal operation of the wire rope assembly, the sensor device can, for example, be integrated in a component of the wire rope assembly. In particular, the sensor device can be designed as a component of the wire rope assembly. In the case of a hoisting installation, such as a crane, the sensor device can, for example, be integrated in a sheave or a rope drum or can be designed as such. This makes it easy to move the wire rope past the sensor device to generate the sensor signal, regardless of the operating state of the wire rope assembly.

The sensor signal preferably characterizes a magnetic interaction between the sensor device and the moving wire rope, in particular the strength of such an interaction. The strength of the interaction or the corresponding sensor signal can serve as a starting point or at least as an indication of the integrity of the wire rope, for example of its condition in particular in the non-visible inner part of the wire rope, i.e. within its sheath. In particular, the signal can be used to assess whether a wire of the wire rope is broken or at least damaged.

The magnetic interaction can be detected, for example, with the aid of an inductance sensor which generates the corresponding sensor signal. The inductance sensor is then expediently designed to measure the inductances of the wire rope, for example, by means of a magnetic field, also referred to as a “test field”, acting on the wire rope. Alternatively, the magnetic interaction can also be detected using a magnetic sensor, for example a Hall sensor. The magnetic sensor is then expediently designed to measure the magnetic field strength of a magnetic field generated or influenced by the wire rope.

With the aid of the sensor device, the integrity of the wire rope, or a measure thereof, can also be determined magneto-inductively. In other words, the sensor device can be used to perform a magneto-inductive measurement on the wire rope. Preferably, this involves generating a saturation magnetization of the wire rope and determining the magnetic flux through the cross section of the wire rope. For this purpose, the sensor device can have a stray field coil or a Hall arrangement (Hall sensor) for detecting a stray field, from which, in turn, the magnetic flux can be derived. Accordingly, the sensor signal can be a magnetic signal that characterizes the magnetic flux through the cross section of the wire rope.

However, other measuring methods are also conceivable. For example, a probe coil, also referred to as a probe head, can be used to detect a change in a magnetic field to which the wire rope is or will be exposed, at least in portions, as a result of the movement of the wire rope relative to the sensor device, and to output this as a voltage signal. For this purpose, the probe coil is preferably wound around a permanent magnet for generating the magnetic field. The sensor signal can be, accordingly, an inductive signal that characterizes a strength of the detected change.

Preferred embodiments of the invention and further refinements thereof are described below, each of which, unless expressly excluded, may be combined with each other and with the aspects of the invention described below, as desired.

In a preferred embodiment, the wire rope is moved past the sensor device in a curved manner. In other words, the wire rope is bent in the region of the sensor device, i.e. in a portion adjacent to the sensor device. For example, the wire rope can be guided over a sheave in the region of the sensor device. In this case, the wire rope can bend around the sensor device at least in portions, for example, if the sensor device is integrated into the sheave or is designed as such. The curvature of the wire rope makes it possible here to determine information regarding the integrity of the wire rope in a particularly stressed state, i.e. at a point of particularly high stress. Since it can be assumed that the integrity of the rope is impaired precisely at such points of heavy loading, the risk that the overall condition of the wire rope is incorrectly assessed, in particular as too good, can thus at least be reduced.

In a further preferred embodiment, a position of the wire rope relative to the sensor device is detected and used as a basis for determining the measure for the integrity of the wire rope. A position of the wire rope relative to the sensor device is here preferably defined by the portion that is currently arranged in the region of the sensor device or is moved past it. That is to say, the position of the wire rope relative to the sensor device may change when the wire rope is moved past the sensor device. In combination with the sensor signal based on the magnetic interaction, the detected position of the wire rope relative to the sensor device allows a particularly differentiated assessment of the condition of the wire rope.

For example, the detected position of the wire rope relative to the sensor device can be used to determine how often a portion of the wire rope currently detected by the sensor device has already passed over a wire rope bearing, such as a sheave, and has been curved or bent in the process and thus subjected to particular stress. Conclusions about the condition of the wire rope can be drawn from the number of corresponding flexion or bending cycles, as well as from the magnetic interaction between the sensor device and the wire rope. With the aid of this information, the wire rope integrity can be assessed even more comprehensively, for example by combining the determined number of flexion or bending cycles with a strength of the magnetic interaction characterized by the sensor signal.

Alternatively or additionally, the determined integrity measure can also be assigned to a portion of the wire rope by detection of the position of the wire rope. In this way, a temporal change in the magnetic interaction can be detected, in particular tracked, and used as the basis for determining the integrity measure.

In order to be able to make predictions, for example, about the service life of the wire rope, it is also conceivable to determine a temporal development of the integrity measure by means of the assignment.

The position of the wire rope relative to the sensor device can be detected, for example, with the aid of a position encoder of a wire rope bearing, in particular a sheave. Such a position encoder can, for example, detect an acceleration, a (rotational) speed and/or an orientation or position of the wire rope bearing. The number of revolutions of the wire rope bearing thus detected can then be transferred to the position of the wire rope relative to the sensor device.

This is particularly advantageous if the sensor device is designed as a wire rope bearing. In this case, the acceleration, the (rotational) speed and/or the orientation or position of the sensor device can be detected and used as the basis for determining the measure for the integrity of the wire rope.

In a further preferred embodiment, the generated sensor signal, in particular the determined measure for the integrity of the wire rope, is assigned to the detected position of the wire rope relative to the sensor device. In particular, the portion of the wire rope currently moving past the sensor device can be assigned to the generated sensor signal. This makes it possible, for example, to track how often the wire rope or the portion has been moved past the sensor device, i.e. how often the integrity measure has already been determined for this portion. In particular, the integrity measure can thus be linked to a useful life or usage cycles. This allows a particularly precise assessment of the condition of the wire rope.

It is also conceivable here that a course of the integrity measure for this portion is determined in this way. If necessary, integrity measures determined for different portions can also be compared with each other. This makes it possible, for example, to detect in good time that one portion is wearing more quickly or more severely than other portions. In this way, the overall condition of the wire rope can be assessed in a particularly differentiated manner and defects in the rope, in particular the development of defects, can be detected at an early stage.

If necessary, the measure for the integrity of the wire rope can also be determined on the basis of the assignment of the sensor signal to the position of the wire rope relative to the sensor device. It is expedient here to determine the number of bends in the region of a wire rope bearing on the basis of the position of the wire rope and to use this, in addition to the sensor signal, as the basis of the determination of the integrity measure. In this way, mechanical wear of the wire rope can be taken into account, even if it has only little or no influence on the sensor signal.

In a further preferred embodiment, a prediction for the development of the integrity of the wire rope is made on the basis of the determined measure for the integrity of the wire rope. For example, it can be estimated for how many operating cycles the wire rope can still be used without hesitation, i.e., for example, without its integrity meeting a predetermined replacement criterion. On the basis of the determined integrity measure, it is possible to predict, for example, a number of still acceptable bending cycles of the wire rope occurring, for example, during guidance over a sheave. In this way, not only can the operational reliability of the wire rope assembly be further increased, but predictive operation can also be realized. In particular, spare parts can be ordered and/or maintenance work planned at an early stage.

It is expedient here if the determined measure for the integrity of the wire rope is logged, i.e. a history or a course of the integrity measure is recorded. On the basis of this log or history, a particularly differentiated and precise prognosis can be made.

In a further preferred embodiment, a check is performed, in particular in automated fashion, to determine whether the determined measure for the integrity of the wire rope meets a replacement criterion. Preferably, a replacement signal is output based on the result of the check. It is expedient to check here whether the determined integrity measure reaches or falls below a predetermined integrity threshold value. If this is the case, the output signal, for example an acoustic and/or visual warning signal, can be output. This enables the wire rope assembly to be shut down in good time, i.e. for example before the wire rope breaks completely, in a particularly reliable manner.

The replacement signal can be output, in particular as an acoustic and/or visual warning signal, to a user, for example to operating or maintenance personnel of the wire rope assembly. Alternatively or additionally, the replacement signal can be output, in particular as a digital or control signal, to a control device that is designed to control the wire rope assembly. This makes it possible to achieve automated shutdown of the wire rope assembly if necessary.

In a further preferred embodiment, the measure for the integrity of the wire rope is determined with the aid of an artificial intelligence. In this case, the artificial intelligence, for example a neural network, is preferably trained to compare the generated sensor signal, in particular changes in the sensor signal, with a predetermined sensor signal and to draw conclusions about the wire rope integrity from the comparison. In this context, the artificial intelligence can be trained, for example, by machine learning. With the aid of the artificial intelligence, patterns in the sensor signal in particular, for example patterns occurring in its temporal course, can be recognized and used as a basis for determining the integrity measure. In this way, the information contained in the sensor signal, in particular in its temporal course, can be used particularly efficiently and comprehensively. This also makes it possible to increase the informative value of the integrity measure.

In another preferred embodiment, the determined measure for the integrity of the wire rope is provided via an interface of the sensor device in a network. The integrity measure can, for example, be communicated via the Internet of Things or retrievable by devices connected to this network. This makes it possible for these devices, for example, to influence the operation of the wire rope assembly and/or to further process the information provided and to initiate processes based thereon. It is conceivable, for example, that predictions of rope requirements and/or maintenance schedules can be generated in this way. This allows extensive and efficient use of the determined information in relation to the wire rope.

In a further preferred embodiment, the wire rope assembly is operated, in particular automatically, as a function of the determined measure for the integrity of the wire rope. In particular, the wire rope assembly can be controlled on the basis of the determined integrity measure. For example, operation of the wire rope assembly may be stopped or at least interrupted when the determined integrity measure meets a predetermined replacement criterion. For this purpose, the determined integrity measure can be processed by a control device for controlling a rope drive and used as a basis for the control. This makes it possible to achieve extensive automation and thus particularly reliable operation of the wire rope assembly.

In a further preferred embodiment, when the magnetic interaction between the wire rope and the sensor device is generated, at least one sensor unit of the sensor device designed to generate the sensor signal moves relative to a stationary component of the wire rope assembly. The at least one sensor unit may, for example, rotate relative to a wire rope bearing, in particular a sheave. In particular, the at least one sensor unit can rotate relative to the sensor device if the sensor unit is designed as a sheave. By moving the at least one sensor unit relative to the stationary component, it can be ensured that the magnetic interaction between the sensor device and the wire rope is large enough to be able to generate the sensor signal reliably and in particular with low noise.

For example, the sensor device, which is designed as a sheave, can have a number of sensor units arranged along the circumference of the sheave, each of which sensor units is mounted so as to be rotatable about an axis of rotation relative to the sheave. In this case, the sensor units preferably each comprise a means for generating a magnetic field and thus the magnetic interaction between the sensor device and the wire rope, and an inductance sensor or magnetic field sensor for detecting the interaction and generating the sensor signal. The sensor units can be actively or passively rotated, for example by gravity in the case of eccentric mounting about the axis of rotation, or by a corresponding drive, such as a gearbox for transmitting the rotational movement of the sheave to each of the sensor units.

An apparatus for monitoring the integrity of a wire rope in a wire rope assembly according to a second aspect of the invention comprises a sensor device designed to generate a sensor signal characterizing a magnetic interaction between the sensor device and the wire rope moving past the sensor device. According to the invention, the wire rope assembly additionally comprises a stationary component in which the sensor device is integrated. It is expedient here that the sensor device is designed as a component of the wire rope assembly, i.e. embodies the component.

A stationary component in the sense of the invention is in particular a fixed or stationary component which does not move in translation during normal operation of the wire rope assembly. However, it is not excluded that the component at least partially executes another movement, for example rotates.

In a preferred embodiment, the apparatus comprises a control device designed to determine a measure for the integrity of the wire rope on the basis of the generated sensor signal.

In another preferred embodiment, the stationary component is a wire rope bearing. In other words, the component is preferably designed to support the wire rope at least in portions. In particular, the component may be designed to support or carry the wire rope at least in portions. This can ensure that the wire rope, during normal operation of the wire rope assembly, can be guided past the sensor device for generating the sensor signal based on the magnetic interaction. In addition, it can thus be ensured that the determined integrity measure corresponds to a portion of the wire rope in which the load on the wire rope is particularly high, in particular maximum.

The wire rope bearing is preferably designed as a sheave or rope drum. In the case of a sheave or rope drum, the wire rope can move along a cheek of the sheave or rope drum under load, at least in portions. In this case, a strength of the magnetic interaction characterized by the sensor signal, for example a strength of the magnetic flux through the cross section of the wire rope, can be determined.

In a further preferred embodiment, the sensor device has a plurality of sensor units for generating the sensor signal, which are arranged along a circumference of the wire rope bearing. The sensor units preferably each have a means for generating a magnetic field, in particular for generating a saturation magnetization in the wire rope, and/or a stray field coil for detecting the magnetic flux through a cross section of the wire rope. By means of a rotation, the sensor units can be repeatedly brought into the immediate vicinity of the wire rope in order to magnetically saturate the latter, for example, at least in portions, and to generate a corresponding sensor signal by detecting the resulting stray field of the magnetic flux through the cross section of the wire rope.

The sensor units, in particular the means for generating the magnetic field, can be arranged here in at least one cheek of the sheave, in particular in the region of a groove of the sensor device designed as a wire rope bearing, which groove is designed to guide the wire rope. Such means for generating the magnetic field can, for example, be permanent magnets, in particular bar magnets, which can be accommodated particularly easily in the cheeks of the wire rope bearing, for example in corresponding recesses.

The invention will be explained in more detail on the basis of figures. Where appropriate, elements having the same effect are given the same reference signs herein. The invention is not limited to the embodiments shown in the figures—not even with respect to functional features. The previous description as well as the following description of the figures contain numerous features, some of which are reproduced in combined form in the dependent claims. However, a person skilled in the art will also consider these features as well as all other features disclosed above and in the following description of the figures individually and will combine them into useful further combinations. In particular, all of the stated features can each be combined individually and in any suitable combination with the method according to the first aspect of the invention, the apparatus according to the second aspect of the invention, and the wire rope assembly according to the third aspect of the invention.

The figures show, at least partially schematically:

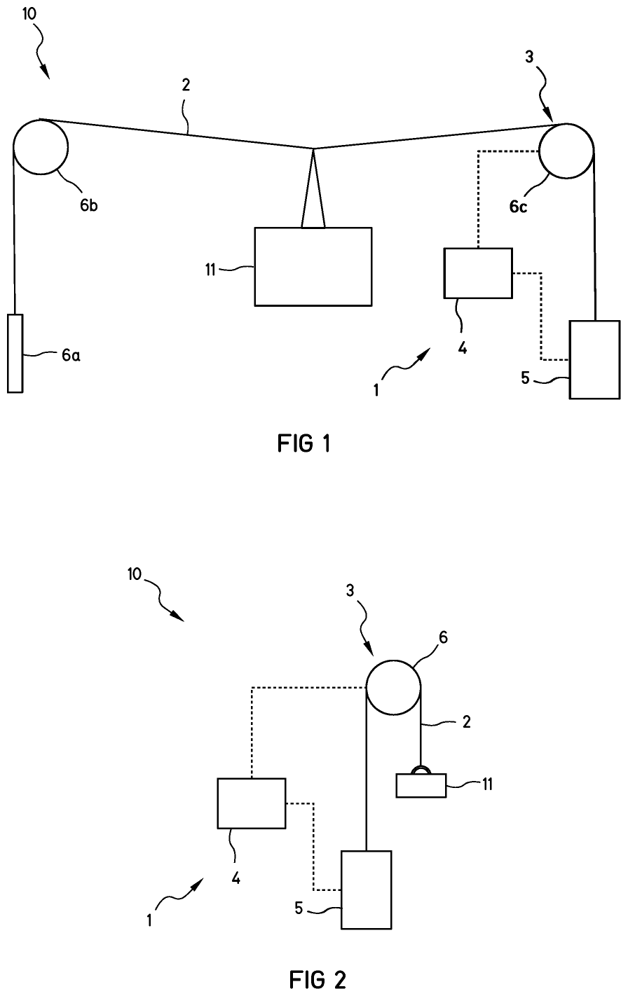

FIG. 1 a first example of a wire rope assembly with an apparatus for monitoring the integrity of a wire rope;

FIG. 2 a second example of a wire rope assembly with an apparatus for monitoring the integrity of a wire rope;

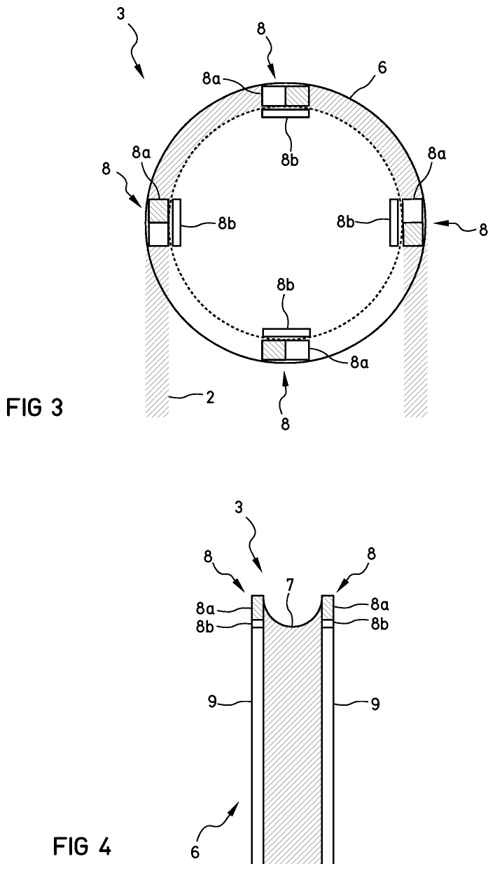

FIG. 3 an example of a sensor device designed as a sheave from a first viewing angle;

FIG. 4 the sensor device from FIG. 3 from a second viewing angle;

FIG. 5 an example of a sensor device designed as a sheave with rotatably mounted sensor units; and

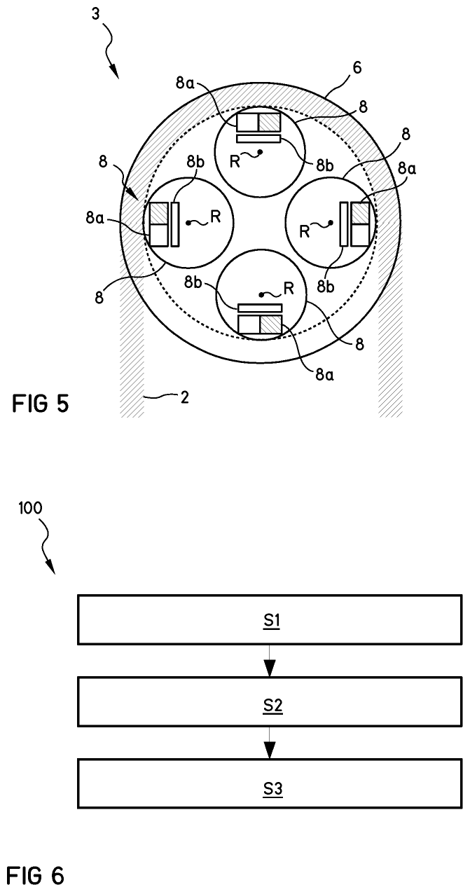

FIG. 6 an example of a method for monitoring the integrity of a wire rope.

FIG. 1 shows a first example of a wire rope assembly 10 comprising a wire rope 2 and an apparatus 1 for monitoring the integrity of the wire rope 2 in a side view. The apparatus 1 comprises sensor device 3 for generating a sensor signal based on a magnetic interaction between the sensor device 3 and the wire rope 2 of the wire rope assembly 10 moving past the sensor device 3, and control means 4 for determining a measure for the integrity of the wire rope 2 based on the sensor signal. In addition to the apparatus 1, the wire rope assembly 10 also has a rope drive 5 for moving the wire rope 2 in a normal operation of the wire rope assembly 10 and a plurality of wire rope bearings 6a, 6b, 6c, three in the example shown. Here, the wire rope 2 is stretched between the wire rope drive 5 and a first one of the wire rope bearings 6a and is guided by a second and a third one of the wire rope bearings 6b, 6c.

In the present example, the wire rope assembly 10 is designed as a cable car installation with a load 11 in the form of a cabin, which is supported by the wire rope 2 and is attached to the wire rope 2. In normal operation, the cabin can thus be moved by the rope drive 5 together with the wire rope 2.

In the present example, the wire rope bearings 6a, 6b and 6c are designed as sheaves over which the wire rope 2 runs at least in portions during normal operation of the wire rope assembly 10. The first wire rope bearing 6a is rotated substantially 90° relative to the second and third wire rope bearings 6b, 6c, so that its axis of rotation runs in the plane of the figure in the example shown. The wire rope 2 is designed as an endless rope that runs from the rope drive 5 to the first wire rope bearing 6a and back again. For this purpose, the rope drive 5 can have a further rope bearing driven by a motor, over which the wire rope 2 is guided (not shown). The returning portion of the wire rope 2, which runs substantially parallel to the outgoing portion, is not shown in FIG. 1 for reasons of clarity.

The wire rope bearings 6a, 6b and 6c are preferably stationary components of the wire rope assembly 10 that are not subject to substantially any translational movement during normal operation of the wire rope assembly 10. In other words, the wire rope bearings 6a, 6b and 6c are rotatably mounted, but are arranged or mounted so as to be substantially stationary.

As shown in FIG. 1, the sensor device 3 is preferably integrated into the third wire rope bearing 6c. In particular, the sensor device 3 is designed in the form of a wire rope bearing so that it can be used as a third wire rope bearing 6c. Since the wire rope 2 thus repeatedly runs past the sensor device 3 during normal operation, the integrity of the wire rope 2 can also be monitored during normal operation of the wire rope assembly 10. The provision of an additional, external checking device is not necessary, nor is the shutting down of the wire rope assembly 10 for maintenance purposes.

In addition to determining the integrity measure, the control device 4 is also designed to control the rope drive 5 and thus the movement of the rope 2 or the load 11 in the form of the cabin. In order to increase operational reliability, the control device 4 can be designed here to check whether the determined integrity measure satisfies a predetermined replacement criterion. If this is the case, i.e., if the determined integrity measure reaches or falls below a predetermined integrity threshold value, for example, the control device 4 can stop the operation of the wire rope assembly 10 until the wire rope 2 has been replaced or at least subjected to further maintenance and/or repaired.

FIG. 2 shows a second example of a wire rope assembly 10 with a wire rope 2 and an apparatus 1 for monitoring the integrity of the wire rope 2 in a side view. Here, the wire rope assembly 10 is designed as a hoisting installation, which is designed for lifting a load 11 attached to the wire rope 2.

Analogously to the example shown in FIG. 1, the apparatus 1 comprises a sensor device 3 for generating a sensor signal based on a magnetic interaction between the sensor device 3 and the wire rope 2 of the wire rope assembly 10 moved past the sensor device 3, and a control device 4 for determining a measure for the integrity of the wire rope 2 based on the sensor signal. In addition to the apparatus 1, the wire rope assembly 10 also has a rope drive 5 for moving the wire rope 2 in a normal operation of the wire rope assembly 10.

The sensor device 3 is integrated in a wire rope bearing 6 of the wire rope assembly 10. This allows the wire rope 2 to be guided past the sensor device 3 during normal operation of the wire rope assembly 10.

The hoisting installation shown in FIG. 2 can be a crane, for example. The wire rope bearing 6 with the sensor device 3 can also be part of a bearing system, for example, a pulley block or similar.

Here too, the control device 4 may be intended for controlling the rope drive 5 based on the determined integrity measure.

FIG. 3 shows a sensor device 3 designed as a sheave 6 for monitoring a wire rope 2 of a wire rope assembly from a first viewing angle. The side face of the sheave 6 runs in the plane of the figure.

The sensor device 3 is designed to guide the wire rope 2 at least in portions along its circumference. For this purpose, the sensor device 3 has a groove 7 running along its circumference for at least partially receiving the wire rope 2. The bottom of the groove is shown as a dashed line in FIG. 2.

Because the sensor device 3 guides the wire rope 2 at least in portions with the aid of the groove 7, the wire rope 2 is guided past the sensor device 3 during normal operation of the wire rope assembly. In the process, the wire rope 2 is bent or curved in the portion in which it contacts the sensor device 3.

The sensor device 3 is designed to generate a sensor signal on the basis of a magnetic interaction between the sensor device 3 and the wire rope 2 moving past the sensor device 3, on the basis of which sensor signal a measure for the integrity of the wire rope 2 can be determined. For this purpose, the sensor device 3 may have a plurality of sensor units 8 arranged along its circumference, with the aid of which the sensor device 3 can, for example, perform magneto-inductive measurements on the wire rope 2.

In the example shown, the sensor units 8 each have, for this purpose, a means 8a for generating a magnetic field, for example in the form of a permanent magnet, and a stray field coil 8b. The means 8a for generating a magnetic field can be used to achieve saturation magnetization of the wire rope 2 in the region of the particular means 8a. The stray field coils 8b are expediently each arranged to detect the magnetic flux generated thereby through the cross section of the wire rope 2. If individual wires of the wires from which the wire rope 2 is wound or braided are damaged or even broken, the magnetic flux passing through the cross section drops. The electrical signals generated by the stray field coils 8b when detecting the magnetic flux can therefore be used as the basis for determining a measure for the integrity of the wire rope 2.

If necessary, the sensor units 8 can also be part of a position encoder of the sheave 6 or sensor device 3, which is designed to detect the orientation or position of the sheave 6 or sensor device 3. For this purpose, the sensor units 8 can, for example, have acceleration and/or speed sensors (not shown), with the aid of which an acceleration or speed of the sheave 6 or sensor device 3 can be determined. The orientation or position of the sheave 6 or sensor device 3 can then be derived from the detected acceleration or speed. For example, the number of revolutions performed by the sheave 6 or sensor device 3 can be counted in this way. This information corresponds to the position of the wire rope 2 relative to the sensor device 3, in particular of a portion of the wire rope 2. This makes it possible to assign the determined integrity measure to this portion of the wire rope 2 and, for example, to track the development or course of the integrity in this portion. If necessary, however, this information can also be taken into account when determining the integrity measure, for example, by including the number of bending cycles caused by the sheave 6 in the calculation of the integrity measure.

FIG. 4 shows the sensor device 3 in the form of a sheave 6 from FIG. 3 from a second viewing angle, which differs by 90° from the first viewing angle. The side surface of the sheave 6 is perpendicular to the plane of the figure. The wire rope is not shown in FIG. 4.

FIG. 4 clearly shows that the sensor units 8 are arranged in the region of the groove 7 of the sensor device 3, i.e., in a radially outer region of the sensor device 3. In this case, the sensor units 8 are embedded in the mutually opposing cheeks 9, which laterally delimit the groove 7, of the sheave 6 formed by the sensor device 3 in order to generate the magnetic field passing through the cross section of the wire rope accommodated by the groove 7.

FIG. 5 shows an example of a sensor device 3 designed as a sheave 6 with rotatably mounted sensor units 8. Analogously to the example shown in FIG. 3, the sensor device 3 is designed to guide a wire rope 2 at least in portions along its circumference. In this case, the wire rope is guided past the sensor device 3 in a normal operation of a corresponding wire rope assembly and is bent or curved in the portion in which it contacts the sensor device 3. The sensor device 3 is designed to generate a sensor signal based on a magnetic interaction between the sensor device 3 and the wire rope 2, based on which a measure for the integrity of the wire rope 2 can be determined.

A plurality of sensor units 8 arranged along the circumference of the sensor device 3 each have a means 8a for generating a magnetic field and a stray field coil 8b for detecting a magnetic flux, through the cross section of the wire rope 2, generated with the aid of the means 8a.

In contrast to the example shown in FIG. 3, the present sensor units 8 are each mounted so that they can rotate about a rotation axis R. The means 8a and stray field coils 8b can, for example, be mounted on correspondingly rotatable supports. As a result, the sensor units 8, in particular the means 8a for generating a magnetic field, can additionally be moved relative to the wire rope 2, in particular even when the sheave 6 is stationary. As a result, not only can a magnetic interaction which is characteristic of the integrity of the wire rope 2 due to a changing magnetic field, for example an inductance, be detected in the portion of the wire rope 2 located in the region of the sensor device 3 even when the sheave 6 is stationary, but advantageously also when the sheave 6 is rotating slowly. In particular, it can be ensured that a change in the magnetic flux in the wire rope 2 due to a relative rotation of the means 8a for generating a magnetic field about the axes of rotation R is large enough that a corresponding usable sensor signal can be generated with the stray field coils 8b.

The sensor units 8 can be actively or passively rotatable relative to the sensor device 3 or the sheave 6. The sensor units 8 can, for example, be mounted so that they can rotate freely, so that they rotate automatically due to gravity when the sensor device 3 rotates about the axis of rotation R rotating with the sensor device 3. For this purpose, it is also conceivable to mount the sensor units 8 so that they can rotate eccentrically about the axes of rotation R. Passive rotation has the advantage that it can be realized with low effort and in an energy-efficient manner.

Alternatively, the sensor units 8 can be actively rotated about the rotation axes R with the aid of a corresponding drive. This has the advantage over passive rotation that the speed of rotation of the sensor units 8 and thus, for example, the change in the magnetic flux in the wire rope 2 generated with the aid of the means 8a can be controlled. If necessary, this allows the magnetic interaction between the sensor device 3, in particular the sensor units 8, to be amplified in such a way that a low-noise signal can be generated.

FIG. 6 shows an example of a method 100 for monitoring a wire rope of a wire rope assembly.

In this case, the wire rope is moved past a sensor device in a method step S1, namely in a normal operation of the wire rope assembly. For this purpose, the sensor device can be integrated into a stationary component of the wire rope assembly, which is preferably designed to support or guide the wire rope, or even form this component.

In a second method step S2, the sensor device is used to generate a sensor signal that characterizes a magnetic interaction between the sensor device and the wire rope moving past the sensor device. For example, a magnetic flux through a cross section of the wire rope in the region of the sensor device can be detected and a corresponding signal, also said to be magneto-inductive, can be generated. Alternatively, for example, a change in a magnetic field penetrated by the wire rope can be detected and a corresponding signal, also said to be inductive, can be generated.

In a further method step S3, a measure for the integrity of the wire rope is determined, for example with the aid of a control device, on the basis of the sensor signal generated. This integrity measure can be used, for example, as the basis for controlling the wire rope assembly. Alternatively or additionally, maintenance work or repairs to the wire rope assembly, in particular the wire rope, can also be planned with the aid of the integrity measure, in particular a temporal development or history of the integrity measure preferably recorded for this purpose.

### LIST OF REFERENCE SIGNS

1 Apparatus
2 Wire rope
3 Sensor device
4 Control device
5 Rope drive
6, 6a-c Wire rope bearing
7 Groove
Sensor unit
8a Means for generating a magnetic field
8b Stray field coil
9 Cheek
10 Wire rope assembly
11 Load
100 Method
S1-S3 Method step
R Axis of rotation cm. 1-14. (canceled)

15. A method for monitoring an integrity of a wire rope in a wire rope assembly, which comprises the steps of:
moving the wire rope past a sensor device;
generating a sensor signal characterizing a magnetic interaction between the sensor device and the wire rope moving past the sensor device with an aid of the sensor device; and
determining a measure for the integrity of the wire rope on a basis of the sensor signal generated, wherein a movement of the wire rope is generated in a normal operation of the wire rope assembly.

16. The method according to claim 15, which further comprises moving the wire rope past the sensor device in a curved manner.

17. The method according to claim 15, which further comprises detecting a position of the wire rope relative to the sensor device and the position detected forms a basis of a determination of the measure for the integrity of the wire rope.

18. The method according to claim 17, which further comprises assigning the sensor signal to the position detected of the wire rope relative to the sensor device and the measure for the integrity of the wire rope is determined on a basis of the assigning step.

19. The method according to claim 15, which further comprises making a prediction for a development of the integrity of the wire rope on a basis of the measure determined for the integrity of the wire rope.

20. The method according to claim 15, which further comprises checking whether the measure determined for the integrity of the wire rope satisfies a replacement criterion and a replacement signal is output on a basis of a result of the checking step.

21. The method according to claim 15, which further comprises determining the measure for the integrity of the wire rope with an aid of artificial intelligence.

22. The method according to claim 15, which further comprises providing the measure determined for the integrity of the wire rope in a network via an interface of the sensor device.

23. The method according to claim 15, which further comprises operating the wire rope assembly in dependence on the measure determined for the integrity of the wire rope.

24. The method according to claim 15, wherein when the magnetic interaction between the wire rope and the sensor device is generated, moving at least one sensor unit of the sensor device relative to a stationary component of the wire rope assembly, the sensor device being configured to generate the sensor signal.

25. An apparatus for monitoring an integrity of a wire rope in a wire rope assembly, the apparatus comprising:
a sensor device configured to generate a sensor signal being based on a magnetic interaction between said sensor device and the wire rope moving past said sensor device; and
a stationary component of the wire rope assembly, in which said stationary component said sensor device is integrated.

26. The apparatus according to claim 25, wherein said stationary component is a wire rope bearing.

27. The apparatus according to claim 26, wherein said sensor device contains a plurality of sensor units for generating the sensor signal, said sensor units are disposed along a circumference of said wire rope bearing.

28. A wire rope assembly, comprising
the apparatus according to claim 25.

29. The wire rope assembly according to claim 28, wherein wire rope assembly is a hoisting installation.
